(19) United States
(12) Patent Application Publication
(10) Pub. No.: US 2026/0162192 A1
(43) Pub. Date: Jun. 11, 2026

(54) QUANTIFYING CROP YIELD

(71) Applicants: Anderson Safre, Logan, UT (US); Brent Black, North Logan, UT (US)

(72) Inventors: Anderson Safre, Logan, UT (US); Brent Black, North Logan, UT (US)

(73) Assignee: Utah State University, Logan, UT (US)

(21) Appl. No.: 19/411,072

(22) Filed: Dec. 5, 2025

Related U.S. Application Data
(60) Provisional application No. 63/729,237, filed on Dec. 6, 2024.

(51) Int. Cl. G06Q 50/02; G06Q 10/0631

(52) U.S. Cl. CPC G06Q 50/02; G06Q 10/06315

(57) ABSTRACT

A method for quantifying crop yield includes detecting, via a sensor, a first removal event that includes a removal of a first container from a vehicle. The method includes detecting, via the sensor, a second removal event that includes a removal of a second container from the vehicle. The method includes determining a first location of the vehicle at the first removal event and determining a second location of the vehicle at the second removal event. The method includes determining a distance between the first location and the second location to determine a travel distance of the vehicle. The method includes determining a crop yield level based at least in part on the travel distance of the vehicle. The method includes generating, based on the travel distance, a yield map that includes a visual representation of the geographic area. The visual representation includes an indicator of the crop yield level.

### CROSS-REFERENCE TO RELATED APPLICATIONS

The application claims the benefit of United States Provisional Patent Application Number 63/729,237 entitled “QUANTIFYING CROP YIELD” and filed on Dec. 6, 2024, for Anderson Safre and Brent Black, which is incorporated herein by reference.

### GOVERNMENT SUPPORT

This invention was made with government support under 2021-51181-35868 awarded by the National Institute of Food and Agriculture. The government has certain rights in the invention.

### FIELD

This invention relates to crop yield analysis, and particularly to quantifying crop yield.

### BACKGROUND

Agricultural vehicles equipped with sensors, controllers, and/or harvesting mechanisms can be used to perform field operations, such as harvesting, gathering, or processing crop material. As these vehicles travel across large acreage, they may harvest crops from plants that they pass. Modern precision agriculture includes data-driven techniques to monitor field conditions, optimize planting decisions, and enhance the overall performance of these crops.

### SUMMARY

Examples of the present disclosure include a method for quantifying crop yield. The method includes detecting, via a sensor, a first removal event. The first removal event includes a removal of a first container from a vehicle. The method includes detecting, via the sensor, a second removal event subsequent to the first removal event. The second removal event includes a removal of a second container from the vehicle. The method includes determining a first location of the vehicle at the first removal event. The method includes determining a second location of the vehicle at the second removal event. The method includes determining a distance between the first location and the second location and determining, based at least in part on the distance between the first location and the second location, a travel distance of the vehicle. The method includes determining a crop yield level based at least in part on the travel distance of the vehicle. The crop yield level corresponds to a portion of a geographic area that includes the first location and the second location. The method includes generating, based at least in part on the travel distance, a yield map. The yield map includes a visual representation of the geographic area. The visual representation includes an indicator of the crop yield level.

Examples of the present disclosure include a system. The system includes a proximity sensor configured to detect a first removal event. The first removal event includes a removal of a first container from a vehicle. The proximity sensor is configured to detect a second removal event. The second removal event includes a removal of a second container from the vehicle. The system includes a location sensor that is configured to determine a first location of the vehicle at the first removal event and determine a second location of the vehicle at the second removal event. The system includes a processor configured to determine a distance between the first location and the second location and determine, based at least in part on the distance between the first location and the second location, a travel distance of the vehicle. The processor is configured to determine a crop yield level based at least in part on the travel distance of the vehicle. The crop yield level corresponds to a portion of a geographic area includes the first location and the second location. The processor is configured to generate, based at least in part on the travel distance, a yield map. The yield map includes a visual representation of the geographic area. The visual representation includes an indicator of the crop yield level.

Examples of the present disclosure include a system. The system includes a vehicle and a proximity sensor onboard the vehicle. The proximity sensor is configured to detect a first removal event. The first removal event includes a removal of a first container from a vehicle. The proximity sensor is configured to detect a second removal event. The second removal event includes a removal of a second container from the vehicle. The system includes a location sensor that is configured to determine a first location of the vehicle at the first removal event and determine a second location of the vehicle at the second removal event. The system includes a processor configured to determine a distance between the first location and the second location and determine, based at least in part on the distance between the first location and the second location, a travel distance of the vehicle. The processor is configured to determine a crop yield level based at least in part on the travel distance of the vehicle. The crop yield level corresponds to a portion of a geographic area includes the first location and the second location. The processor is configured to generate, based at least in part on the travel distance, a yield map. The yield map includes a visual representation of the geographic area. The visual representation includes an indicator of the crop yield level.

### BRIEF DESCRIPTION OF THE DRAWINGS

In order that the advantages of the invention will be readily understood, a more particular description of the invention briefly described above will be rendered by reference to specific examples that are illustrated in the appended drawings. Understanding that these drawings depict only typical examples of the invention and are not therefore to be considered to be limiting of its scope, the invention will be described and explained with additional specificity and detail through the use of the accompanying drawings, in which:

FIG. 1A is a schematic block diagram illustrating a system for quantifying crop yield with a vehicle at a first location, according to various embodiments;

FIG. 1B is a schematic block diagram illustrating a system for quantifying crop yield with a vehicle at a second location, according to various embodiments;

FIG. 1C is a schematic block diagram illustrating a system for quantifying crop yield with a vehicle beyond a third location, according to various embodiments;

FIG. 2 illustrates a diagram illustrating a yield map, according to various embodiments;

FIG. 3A is a perspective view of a system for quantifying crop yield, according to various embodiments;

FIG. 3B is an elevational view of a system for quantifying crop yield, according to various embodiments;

FIG. 4 is a schematic block diagram illustrating a system for quantifying crop yield, according to various embodiments;

FIG. 5 is a schematic block diagram illustrating an apparatus for quantifying crop yield, according to various embodiments;

FIG. 6 is a schematic block diagram illustrating an apparatus for quantifying crop yield based on changes in vehicle velocity, according to various embodiments;

FIG. 7 is a schematic flow chart illustrating a method of quantifying crop yield, according to various embodiments; and

FIG. 8 is a schematic flow chart illustrating a method of quantifying crop yield based on travel distances, according to various embodiments.

### DETAILED DESCRIPTION

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more examples. In the following description, numerous specific details are provided, such as examples of programming, software modules, user selections, network transactions, database queries, database structures, hardware modules, hardware circuits, hardware chips, etc., to provide a thorough understanding of examples of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the examples may be combined in any suitable manner. One skilled in the relevant art will recognize that the examples may be practiced without one or more of the specific features or advantages of a particular example. In other instances, additional features and advantages may be recognized in certain examples that may not be present in all examples.

These features and advantages of the examples will become more fully apparent from the following description and appended claims, or may be learned by the practice of examples as set forth hereinafter. As will be appreciated by one skilled in the art, aspects of the present invention may be embodied as a system, method, and/or computer program product. Accordingly, aspects of the present invention may take the form of an entirely hardware example, an entirely software example (including firmware, resident software, micro-code, etc.) or an example combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

Furthermore, examples may take the form of a program product embodied in one or more computer readable storage devices storing machine readable code, computer readable code, and/or program code, referred hereafter as code. The storage devices, in some examples, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some examples, electronic circuitry including, for example, programmable logic circuitry, field-programmable gate arrays (“FPGAs”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to examples of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various examples of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding examples. Indeed, some arrows or other connectors may be used to indicate only the logical flow of the depicted example. For instance, an arrow may indicate a waiting or monitoring period of unspecified duration between enumerated steps of the depicted example. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate examples of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

Examples of the present disclosure include a method for quantifying crop yield. The method includes detecting, via a sensor, a first removal event. The first removal event includes a removal of a first container from a vehicle. The method includes detecting, via the sensor, a second removal event subsequent to the first removal event. The second removal event includes a removal of a second container from the vehicle. The method includes determining a first location of the vehicle at the first removal event. The method includes determining a second location of the vehicle at the second removal event. The method includes determining a distance between the first location and the second location and determining, based at least in part on the distance between the first location and the second location, a travel distance of the vehicle. The method includes determining a crop yield level based at least in part on the travel distance of the vehicle. The crop yield level corresponds to a portion of a geographic area that includes the first location and the second location. The method includes generating, based at least in part on the travel distance, a yield map. The yield map includes a visual representation of the geographic area. The visual representation includes an indicator of the crop yield level.

In some examples, the method includes determining a first time of the first removal event and determining a second time of the second removal event. In some examples, determining the crop yield level of the portion of the geographic area is further based at least in part on a difference between the second time and the first time.

In some examples, determining the first location and the second location is based at least in part on one or more measurements from at least one of an Inertial Measurement Unit (IMU) and a Global Navigation Satellite System (GNSS) receiver located on the vehicle. The method includes determining, based at least in part on the one or more measurements, a change in velocity of the vehicle and updating at least one of the first location and the second location based at least in part on the change in velocity.

In some examples, the method includes harvesting, via a harvester, a crop from a plant of a plurality of plants and transferring the crop into at least one of the first container and the second container. The first removal event and the second removal event each include removing of a bin that includes the harvested crop.

In some examples, the method includes receiving, from a user, input that includes a location of a plurality of rows of the plurality of plants. Generating the yield map is further based at least in part on the location of the plurality of rows. In some examples, the method includes calculating the portion of the geographic area based at least in part on the travel distance and a width of each row of the plurality of rows.

In some examples, the method includes receiving input from a user. The input includes a location of a border of the geographic area. The method includes determining a distance between the border and at least one of the first location and the second location. The travel distance is further based at least in part on the determined distance between the border and the at least one of the first location and the second location.

In some examples, the sensor includes an ultrasonic proximity sensor configured to iteratively perform measurements at a predetermined time interval. In some examples, the ultrasonic proximity sensor is configured to detect at least one of the first removal event and the second removal event by detecting at least one of a presence or a lack of presence of at least one of the first container and the second container in the vehicle.

In some examples, the method includes repeating detecting first and second removal events, determining additional first and second locations of the vehicle, determining additional distances between the additional first and second locations, determining additional travel distances of the vehicle, and determining additional crop yield levels for the additional travel distances. In some examples, generating the yield map includes generating the yield map based on the travel distance and the additional travel distances. The indicator includes a first overlay over a first map portion of a map of the geographic area. The first map portion corresponds to the portion of the geographic area. Generating the yield map based on the additional travel distances includes generating an additional indicator on the yield map. The additional indicator includes a second overlay over a second map portion of the map. The second map portion corresponds to an additional portion of the geographic area. The additional portion includes the additional first and second locations. The first overlay borders the second overlay.

Examples of the present disclosure include a system. The system includes a proximity sensor configured to detect a first removal event. The first removal event includes a removal of a first container from a vehicle. The proximity sensor is configured to detect a second removal event. The second removal event includes a removal of a second container from the vehicle. The system includes a location sensor that is configured to determine a first location of the vehicle at the first removal event and determine a second location of the vehicle at the second removal event. The system includes a processor configured to determine a distance between the first location and the second location and determine, based at least in part on the distance between the first location and the second location, a travel distance of the vehicle. The processor is configured to determine a crop yield level based at least in part on the travel distance of the vehicle. The crop yield level corresponds to a portion of a geographic area includes the first location and the second location. The processor is configured to generate, based at least in part on the travel distance, a yield map. The yield map includes a visual representation of the geographic area. The visual representation includes an indicator of the crop yield level.

In some examples, the location sensor is further configured to record a first timestamp for the first removal event and record a second timestamp for the second removal event. The processor is further configured to determine a time of the first removal event based on the first timestamp, determine a time of the second removal event based on the second timestamp, and determine the crop yield level of the portion of the geographic area based at least in part on a difference between the second time and the first time.

In some examples, the location sensor includes at least one of an Inertial Measurement Unit (IMU) and a Global Navigation Satellite System (GNSS) receiver located on the vehicle. In some examples, the IMU is configured to determine, based at least in part on one or more measurements, a change in velocity of the vehicle. The processor is further configured to update at least one of the first location and the second location based at least in part on the change in velocity.

In some examples, the system includes a harvester configured to harvest a crop from a plant of a plurality of plants and transfer the crop into at least one of the first container and the second container. The first removal event and the second removal event each include removing of a bin that includes the harvested crop.

In some examples, the proximity sensor includes an ultrasonic proximity sensor configured to iteratively perform measurements at a predetermined time interval. In some examples, the ultrasonic proximity sensor is configured to detect at least one of the first removal event and the second removal event by detecting at least one of a presence or a lack of presence of at least one of the first container and the second container in the vehicle.

Examples of the present disclosure include a system. The system includes a vehicle and a proximity sensor onboard the vehicle. The proximity sensor is configured to detect a first removal event. The first removal event includes a removal of a first container from a vehicle. The proximity sensor is configured to detect a second removal event. The second removal event includes a removal of a second container from the vehicle. The system includes a location sensor that is configured to determine a first location of the vehicle at the first removal event and determine a second location of the vehicle at the second removal event. The system includes a processor configured to determine a distance between the first location and the second location and determine, based at least in part on the distance between the first location and the second location, a travel distance of the vehicle. The processor is configured to determine a crop yield level based at least in part on the travel distance of the vehicle. The crop yield level corresponds to a portion of a geographic area includes the first location and the second location. The processor is configured to generate, based at least in part on the travel distance, a yield map. The yield map includes a visual representation of the geographic area. The visual representation includes an indicator of the crop yield level.

Yield maps can provide insights into crop performance and help to inform decisions by revealing variations in crop yield across a particular area, such as a field or an orchard, highlighting areas of low and high yield. From these area indications, managers of agriculture can begin to understand factors influencing differences in yield, such as a soil quality, drainage, pest infestation, or nutrient deficiencies. Analysis of yield maps can also help to identify trends and patterns in crop performance and provide insight into the impact of management practices, weather patterns, and other factors on productivity. Quantifying crop yield for yield maps can be time-consuming and expensive, often involving complex calculations and/or several weight measurements that can interrupt harvesting. Examples of the present disclosure include methods, systems, and apparatuses that can help to improve efficiency and reduce overall time in quantifying crop yield. Examples of the present disclosure can help to minimize interruptions to a harvesting route while still providing accurate crop yield data.

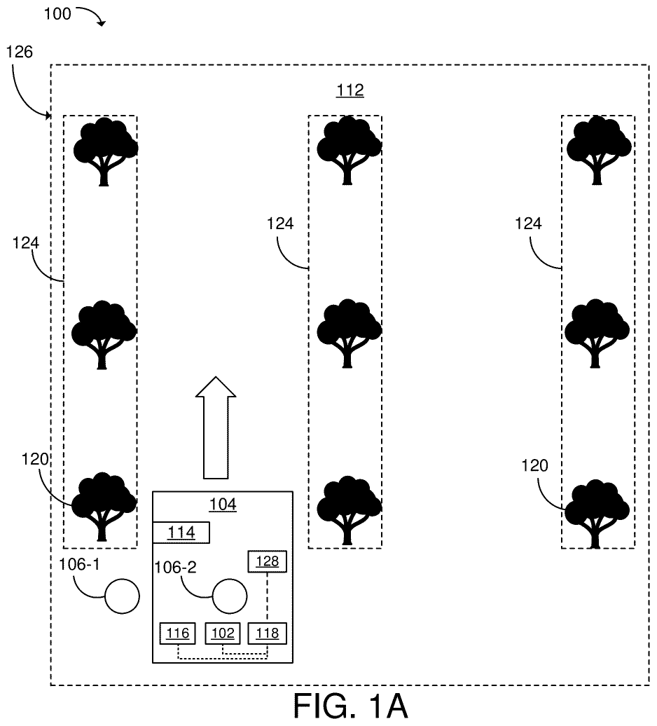

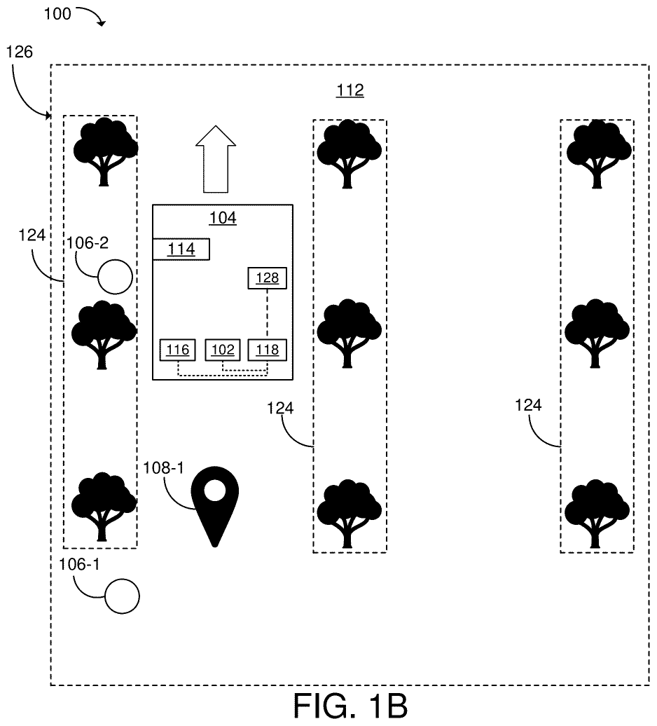

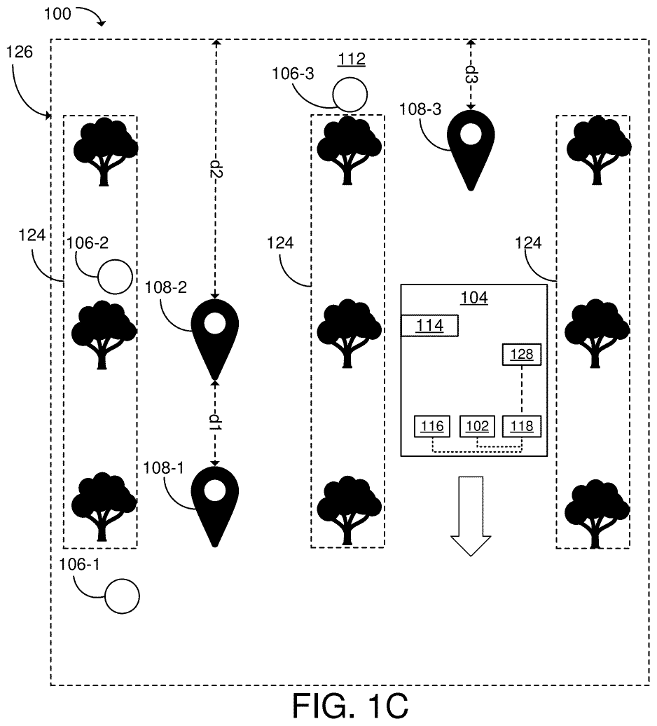

FIG. 1A is a schematic block diagram illustrating one example of a system 100 for quantifying crop yield. In some examples, the system 100 includes a vehicle 104 that moves through a geographic area 112 to harvest crops from plants 120 using a harvester 114. The system 100 includes a proximity sensor 102, a GNSS receiver 116, an IMU 128, and/or processor 118.

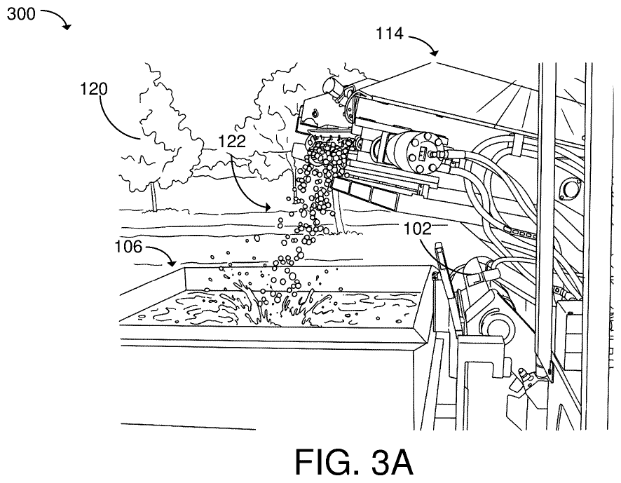

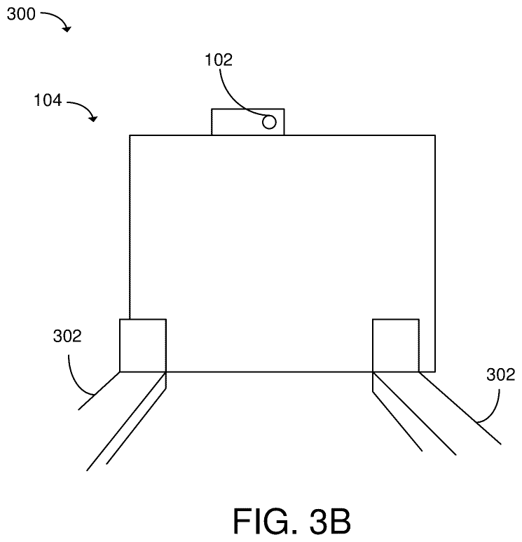

In some examples, the geographic area 112 includes at least one of: an orchard, a field, a garden, a vineyard or a greenhouse. In some examples, the plants 120 include at least one of: a tree, a bush, a vine, or any other plant bearing an agricultural product that can be harvested from the plant 120. In some examples, the crop (e.g., crop 122 shown in FIG. 3A) includes at least one of: cherries, nuts, grains, vegetables, fruit, wheat, beans, or corn. In some examples, the crop includes the plant 120 itself, and removing the crop from the plant 120 includes removing the entire plant 120.

In various examples, the plants 120 are arranged in rows 124 within the geographic area 112. In one or more examples, the vehicle 104 moves between rows 124 to harvest crop from the plants 120. In some examples, the system 100 includes a harvester 114 that is part of and/or onboard the vehicle 104 and is configured to remove a crop from a plant 120 of the plurality of plants 120 and transfer the crop into a container 106-1, 106-2, 106-3 (referred to herein, individually and/or collectively, as “106”) located on the vehicle 104. Although the harvester 114 is illustrated in FIGS. 1A-C as being aboard and/or part of the vehicle 104, examples of the present disclosure are not so limited. In some examples, the harvester 114 is separate from the vehicle 104. In some embodiments, the vehicle 104 pulls a trailer that holds the container 106. In some examples, the harvester 114 includes a shaker that is external to the vehicle 104 and is configured to shake the plant 120 to cause the crop to fall from the plant 120. In some examples, the harvester 114 also includes a conveyor belt onboard the vehicle 104 that directs the crops into the container 106. In some examples, the system 100 harvests, via the harvester 114, a crop from a plant 120 and transfers the crop into a container 106 onboard the vehicle 104.

In some examples, after a container 106 on the vehicle 104 has become full, reached a capacity, and/or reached a threshold weight and/or fill level, the container 106 is removed from the vehicle 104, either automatically via machinery or manually by a user. In some examples, the container 106 includes a bin or any other container or vessel suitable for holding the harvested crop. In some examples, the system 100 includes one or more components configured to detect removal of the container 106 and quantify crop yield accordingly. In some examples, the system 100 includes a proximity sensor 102, a processor 118, and/or a location sensor including at least one of a Global Navigation Satellite System (“GNSS”) receiver 116 and an Inertial Measurement Unit (“IMU”) 128.

In some examples, the proximity sensor 102, location sensor, and/or processor 118 make up one apparatus for quantifying crop yield. In some examples, the apparatus is powered by a power source already available on the vehicle 104, such as an alternator and/or a battery powering the harvester 114. As illustrated in FIGS. 1A-C and 3A-B, in some examples, the proximity sensor 102, GNSS receiver 116, IMU 128, and/or processor 118 are positioned on the vehicle 104 and move with the vehicle 104. In some examples, the proximity sensor 102, the IMU 128, and the GNSS receiver 116 are each in communication with the processor 118. However, examples of the present disclosure are not so limited. In some examples, the processor 118 is located outside of the vehicle 104 and/or includes a remote processor not located within the geographic area 112. In some examples, the proximity sensor 102 is positioned externally to the vehicle 104.

In some examples, the processor 118 includes at least one of a controller, a microcontroller, a computer, a microcomputer, a mobile device, an embedded processing module, an industrial control unit, an FPGA, a programmable logic controller, a single-board computer, and/or a dedicated processing circuit configured to execute yield-calculation algorithms. In some examples, one or more of the processor 118, proximity sensor 102, GNSS receiver 116, and/or IMU 128 is powered by a power supply of the harvester 114. In some examples, this power supply is activated by the ignition switch of the harvester 114 to help ensure that the components operate only during harvest activities, preventing unnecessary battery drain.

In some examples, the proximity sensor 102 includes a sensor having a detection range of approximately 0.3 meter (m) to 5.0 m and a sampling rate of about 7.5 hertz (Hz). In some examples, to help optimize the sensor's resolution, the proximity sensor 102 is supplied with a voltage input (e.g., 5 volts (V)) using a power line or output pin of the processor 118. However, in some examples, the communication interface of the processor 118 is configured to receive signals at a lower voltage level (e.g., 3.3 V). In such examples, the serial output of the proximity sensor 102 is interfaced with the processor 118 through a bi-directional logic-level conversion circuit that safely steps down the 5 V signals from the sensor to levels suitable for the processor 118. In some examples, the GNSS receiver 116 also communicates with the processor 118 via bi-directional logic-level conversion in this circuit.

In some examples, the proximity sensor 102 is configured to detect a removal event. The removal event, in some examples, includes a removal of the container 106 from the vehicle 104. In some examples, removal of the container 106 from the vehicle 104 includes a long-term removal of the container 106 from the vehicle 104. In some examples, the removal of the container 106 from the vehicle 104 includes temporarily lifting the container 106 from the vehicle 104 to empty the crop from the container 106. In some examples, by using the container 106 as a unit of crop yield, the system 100 can quantify crop yield by tracking a quantity of removal events over a particular distance within the geographic area 112.

In some examples, the proximity sensor 102 includes an ultrasonic proximity sensor. The ultrasonic proximity sensor, in some examples, is configured to iteratively perform measurements at a determined time interval. In some examples, the proximity sensor 102 is configured to detect the presence of objects on the vehicle, such as the container 106. The proximity sensor 102 also detects, in some examples, the absence of previously detected objects, such as previously detected containers 106. In some examples, the processor 118 is configured to actuate the proximity sensor 102 to measure a distance between the proximity sensor 102 and an object. In some examples, the proximity sensor 102 iteratively measures this distance at a predetermined interval (e.g., 5 seconds).

In some examples, the proximity sensor 102 includes a Radio Frequency Identification (“RFID”) reader. In some examples, the container 106 includes an RFID tag, and the RFID reader is configured to detect and/or scan the RFID tag to detect presence and/or removal of the container 106. In various examples, the proximity sensor 102 is configured to only detect RFID tags within a threshold distance of the proximity sensor 102 in a particular direction. In some embodiments, each container 106 includes a unique identifier stored in the RFID of the container 106 and the proximity sensor 102 reads and tracks the unique identifier of each container 106 with an RFID read by the proximity sensor 102. In some embodiments, each unique identifier is correlated with information about the container 106, such as a volume of the container 106, weight of the container 106, etc.

In some examples, the proximity sensor 102 determines a distance between the container 106 and the proximity sensor 102. In various examples, in response to the measured distance being greater than a previously measured distance and/or greater than a threshold distance (e.g., 1 meter), the proximity sensor 102 detects a removal event. In some examples, the processor 118 iteratively collects data from the proximity sensor 102. In some examples, the processor 118 determines whether the distance between a detected object (e.g., a container 106) and the proximity sensor 102 is less than a predetermined distance (e.g., 1 m) at a given periodicity (e.g., 5 seconds). In response to the distance being equal to or greater than the predetermined distance, the system 100 stores a location measurement received from a location sensor, such as the GNSS position received from the GNSS receiver 116. In some examples, the increased distance indicates removal of the container 106.

In some examples, the GNSS receiver 116 is part of a Global Positioning System (“GPS”) that uses satellite information to determine location. In various examples, the GNSS receiver 116 includes an antenna, signal-processing circuitry, and/or firmware configured to receive and decode signals transmitted by a constellation of satellites. In some examples, the GNSS receiver 116 generates latitude, longitude, altitude, and time data that can be used by the processor 118 to determine the location of the vehicle 104, such as the position within the geographic area 112. In some examples, the GNSS receiver 116 operates in multiple frequency bands to improve accuracy and mitigate signal degradation caused by multipath interference, canopy cover, or terrain variations. In certain examples, the GNSS receiver 116 is further configured to provide real-time kinematic (“RTK”) corrections or differential corrections to increase positional precision during crop-yield measurements.

In some examples, the IMU 128 is configured to detect motion of the vehicle 104 by measuring linear acceleration, angular velocity, and/or orientation relative to gravity. In various examples, the IMU 128 includes one or more accelerometers, gyroscopes, or magnetometers that generate motion data used by the processor 118 to refine, correct, or supplement location information obtained from the GNSS receiver 116. In some examples, the IMU 128 provides higher-frequency updates than the GNSS receiver 116, helping the system 100 to maintain accurate position estimates during periods of signal loss, obstruction, and/or rapid vehicle 104 movement. Due to vehicle 104 deviations from a linear path (e.g., backtracking between filling the container 106 and removing the container 106), the locations determined based on data from the GNSS receiver 116 at removal events may not represent the true locations at which the containers 106 were filled. Using acceleration data from the IMU 128, the processor 118 can make appropriate corrections to the location data to determine actual travel distances between containers 106 being filled rather than just total travel distances between removal events. In some examples, a location of the vehicle 104 at which a backup begins to occur, based on IMU 128 acceleration data, represents a location at which a container 106 was filled. In some examples, the processor 118 calculates travel distances as the distances between fill locations rather than removal locations.

In some examples, the proximity sensor 102 communicates measurements to the processor 118. In some examples, the processor 118 is housed within a housing on the vehicle 104. In various examples, the processor 118 communicates with the proximity sensor 102 and/or the GNSS receiver 116 via wired and/or wireless connections. In some examples, the processor 118 receives data indicating a removal event from a component other than the proximity sensor 102. In some examples, the processor 118 receives a video or images from a camera onboard the vehicle 104 or deployed in an unmanned aerial vehicle, for example, and analyzes the images to detect a removal event. In some example, the processor 118 analyzes the images using an artificial intelligence (“AI”) model trained on a corpus of images of vehicles and/or containers with characteristics similar to the vehicle 104 and/or container 106.

In some examples, the processor 118 records the removal event by performing at least one of the following: storing a location measurement from the GNSS receiver 116, actuating at least one of the IMU 128 and the GNSS receiver 116 to perform a measurement, recording a timestamp, or a combination thereof. In some examples, the processor 118 records the removal event without weighing and/or storing a weight of the harvested crop. In some examples, at least one of the proximity sensor 102, the GNSS receiver 116, and/or IMU 128 records the timestamp automatically in response to the removal event. In some examples, at least one of the proximity sensor 102, the GNSS receiver 116, and/or the IMU 128 records the timestamps with each pulse, measurement, and/or iteration of measurement, regardless of whether or not a removal event is detected.

In some examples, a first removal event includes a first container 106-1 being removed from the vehicle 104. In some examples, the first container 106-1 is originally positioned on the vehicle 104. As shown in FIG. 1A, the first container 106-1 is eventually removed from the vehicle 104. As shown in FIG. 1B, in some examples, the vehicle 104 continues to move along the plants 120 after removal of the first container 106-1. In various examples, the processor 118 determines and/or records a location 108-1 of the vehicle 104 at the first removal event. In some examples, the first location 108-1 represents a location of the vehicle 104 when the container 106-1 was filled.

In some examples, after a removal event, the processor 118 determines that a new container 106-2 has been placed on the vehicle 104. In some examples, the system 100 determines that a new container 106-2 has been placed on the vehicle 104 based on the proximity sensor 102 iteratively measuring the distance between a detected object and the proximity sensor 102 and the processor 118 determining that the distance is less than a threshold (e.g., 1 m). In some examples, the proximity sensor 102 continues to iteratively measure the distance between the proximity sensor 102 and the new container 106-2, and the processor 118 eventually detects removal of the container 106-2.

In some examples, the proximity sensor 102 is positioned proximate to the container 106 and is configured to detect removal and/or filling of the container 106. In some examples, the processor 118 records the removal event when the proximity sensor 102 detects an increased distance between the proximity sensor 102 and the nearest object, indicating removal of the container 106 from the vehicle 104 and/or replacement of the container 106 with an empty container 106. In some examples, the processor 118 records the removal event when the proximity sensor 102 detects a decreased distance between the proximity sensor 102 and the nearest object, indicating a higher fill level of the container 106.

In some examples, the processor 118 is configured to determine a location of the vehicle 104 at each removal event and use the distance traveled by the vehicle 104 between removal events to quantify crop yield. In some examples, the processor 118 determines the location of the vehicle 104 at the removal event based at least in part on a measurement from the location sensor(s) located on the vehicle. For example, the processor 118 determines locations of the vehicle 104 at the removal events based on measurements from the GNSS receiver 116 located on the vehicle 104 and corrects the determined locations based on measurements from the IMU 128.

In some examples, the system 100 corrects location data measured by the GNSS receiver 116 based at least in part on an antenna offset. In some examples, the antenna offset refers to a physical displacement between an antenna of the GNSS receiver 116 mounted on the vehicle 104 and the actual point at which crop removal occurs. Because the antenna may be positioned forward, rearward, or laterally relative to the harvester 114, the location reported by the GNSS receiver 116 may not directly correspond to the true removal location. In various examples, the processor 118 applies a correction factor to account for this displacement so that each removal event is associated with an accurate ground position of the harvester. In some examples, compensating for antenna offset helps to improve the precision of distance measurements between removal events and thereby helps to enhance the accuracy of yield calculations across the geographic area 112.

As shown in FIG. 1B, in some examples, after the first removal event, the vehicle 104 continues to move, and the harvester 114 harvests crop from one or more additional plants 120. In various examples, the first removal event includes the first container 106-1 being removed from the vehicle 104, and a second removal event occurs subsequent to the first removal event. The proximity sensor 102 is configured to detect the second removal event. In some examples, as the harvester 114 transfers crop into containers 106, a second container 106-2 is eventually removed from the vehicle 104, indicating the second removal event. In other examples, the first removal event includes the first container 106-1 being temporarily removed from the vehicle 104, emptied out, and then returned to the vehicle. In some examples, the second removal event includes the first container 106-1 being emptied a second time.

Referring to FIG. 1C, in some examples, the processor 118 determines and/or records the location 108-2 of the vehicle 104 at the second removal event. In some examples, the processor 118 is configured to determine a distance d1 between the locations 108-1 and 108-2 of two consecutive removal events. In one or more examples, the processor 118 is configured to quantify a crop yield based at least in part on this distance d1. In various examples, a crop yield of a particular area within the geographic area 112 is inversely proportional to a distance d1 traveled between removal events.

In some examples, the proximity sensor 102 continues to repetitively detect removal events after detecting the first and second removal events. The processor 118 is configured to determine additional removal locations based on the additional removal events. The processor 118 is also configured, in some examples, to determine additional travel distances based on the additional removal events. In some examples, the crop yield level is based on an average or summation of the travel distances. In some examples, the processor 118 determines different crop yield levels for different portions of the geographic area 112 based at least in part on the additional travel distances. Although only one vehicle 104 is shown in FIGS. 1A-C, examples of the present disclosure are not so limited. In some examples, the data used by the processor 118 to determine the travel distances between removal locations 108 includes data from sensors onboard multiple different vehicles 104 traversing the geographic area 112.

In some examples, the processor 118 is configured to determine a distance traveled by the vehicle 104 based at least in part on the distance d1 between the first location 108-1 and the second location 108-2. In various examples, the distance traveled by the vehicle 104 between two locations 108-1 and 108-2 is not equal to the shortest distance d1 between those locations 108-1 and 108-2.

In one or more examples, the system 100 corrects for vehicle 104 path departures, such as backups. In some examples, the processor 118 determines a change in velocity of the vehicle 104 based at least in part on a measurement from the IMU 128. The processor 118 updates at least one of the determined locations 108 based at least in part on the change of velocity. As used herein, a change of velocity refers to at least one of a change of raw speed, a change of momentum, a change in direction of movement, movement in any of multiple degrees of freedom, movement around an axis, rotation, pitch, roll, yaw, or a combination thereof. In some examples, the processor 118 determines the first location 108-1 and the second location 108-2 based on data received from the GNSS receiver 116. In various examples, the processor 118 determines, based on measurements from the IMU 128, that the vehicle 104 changed direction (e.g., backed up) before the second removal event, and the processor 118 corrects the recorded first location 108-1 and second location 108-2 based on the IMU 128 data.

As illustrated in FIGS. 1A-B, in some examples, the recorded removal event locations 108-1, 108-2 used to generate the yield map 200 are displaced from actual removal locations of the containers 106-1, 106-2. In some examples, after a container 106-1 has been filled, the vehicle 104 moves in a reverse direction to drop the container 106-1 off at a location different from the location 108-1 at which the container 106-1 was actually filled. As such, in various examples, the location of the removal of the container 106 does not reflect the location of the container 106 being filled. In some examples, the system 100 is configured to account for such a discrepancy when generating the yield map 200. In some examples, the processor 118 is configured to determine, based at least in part on the one or more measurements from the GNSS receiver 116, a change in direction of movement of the vehicle 104 prior to the recorded removal event. In some examples, the processor 118 is configured to update at least one of the locations 108-1, 108-2 based at least in part on the change in direction. FIGS. 1A-C illustrate examples of such updated locations 108-1, 108-2, and 108-3.

In some examples, the user input includes information regarding backups of the vehicle 104 that could result in physical displacement between the removal of the container 106 from the vehicle 104 and the filling of the container 106. In various examples, the user input includes a backup distance, a quantity of backups, a number of drop-off locations for the container 106, or a combination thereof. In some examples, the processor 118 is configured to modify, update, and/or correct the travel distances data based on this input to more accurately determine the removal event locations 108.

In one or more examples, the processor 118 is configured to determine a crop yield level based at least in part on the travel distance of the vehicle 104. The crop yield level corresponds to a particular portion of a geographic area 112. The portion of the geographic area 112 is a portion that includes the first location 108-1 and the second location 108-2. In some examples, the processor 118 is configured to determine different crop yield levels for a plurality of portions (e.g., adjacent or proximate portions) of the geographic area.

In some examples, the processor 118 calculates a weight of crop yield for a particular area within the geographic location. In some examples, the harvested area can be calculated as the harvested distance (traveled distance) multiplied by the spacing between rows 124. In some examples, the average weight per unit area is the weight of the filled container 106 divided by the harvested area. In some examples the weight is determined based at least in part on: a weight of a plant 120, a unit weight of a filled container 106, a quantity of removal events within the particular area, a distance between removal events, or a combination thereof. In some examples, the system 100 calculates a quantity of plants 120 per container 106.

In some examples, the quantity of plants 120 includes a quantity of plants 120 from which the harvester 114 harvests until a container 106 reaches capacity (i.e., a quantity of plants 120 between removal events). In some examples, the processor 118 assumes that each removed container 106 includes the same weight of crop and determines crop yield levels based on the quantity of containers 106. In other examples, the system 100 includes a scale onboard the vehicle 104 that weights the container 106 before its removal. In some examples, the processor 118 receives that measurement from the scale and determines crop yield levels based on the variable weights of the removed containers 106. In some examples, the system 100 includes a sensor configured to detect a fill level of the container 106. In some examples, that sensor includes at least one of the proximity sensor 102, a camera, and/or a radar sensor. In certain examples, the fill-level sensor is positioned above or adjacent to the container 106 and generates measurement data indicative of the height, volume, or surface profile of the harvested material within the container 106. In some examples, the processor 118 analyzes the fill-level sensor data to determine whether the container 106 has reached a predetermined fill threshold that triggers a removal event. In various examples, the processor 118 is configured to determine a quantity of crop for each removal event based at least in part on the fill level at the time of removal.

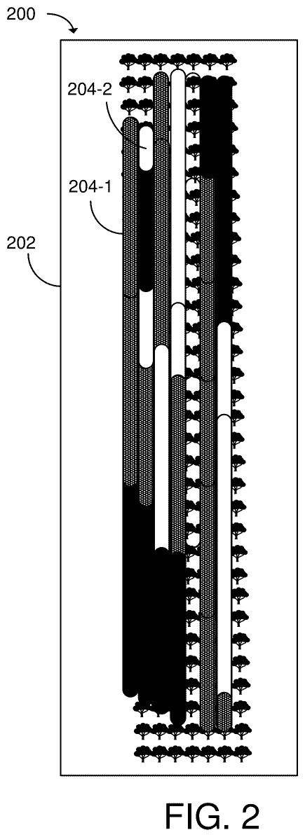

In further examples, the processor 118 is configured to normalize the quantity of removal events or the measured or estimated weights by the size of the corresponding area traversed by the vehicle 104, enabling a yield-per-unit-area calculation. In some examples, the processor 118 correlates the spatial coordinates of each removal event with the measured or assumed weight to generate a georeferenced yield map (e.g., yield map 200 of FIG. 2) that indicates localized variations in crop density. In additional examples, the processor 118 aggregates multiple removal events within a predefined zone and calculates an average or total yield for that zone to characterize crop performance across different portions of the geographic area 112.

In some examples, the processor 118 updates a calculated crop yield level in real-time based at least in part on measurements received from at least one of the proximity sensor 102 and the location sensors (GNSS receiver 116 and IMU 128). In some examples, the real-time updating enables the system 100 to adjust yield calculations based on instantaneous changes in the distance traveled between removal events, thereby reducing latency and improving the accuracy of the yield estimation process. In some examples, the processor 118 uses the sensor measurements to correct positional drift, vibration-induced noise, and/or signal degradation. In additional examples, the processor 118 executes a sensor-fusion algorithm that integrates readings from the proximity sensor 102, the GNSS receiver 116, and the IMU 128 to generate a corrected spatial path of the vehicle 104, enabling a more precise association between measured crop yield and its corresponding location within the geographic area 112. In some examples, these operations allow the system 100 to automatically generate yield information with improved spatial resolution and reduced error.

FIG. 2 illustrates a yield map 200 according to one or more examples of the present disclosure. In some examples, the processor 118 is configured to generate a yield map 200 based at least in part on the determined travel distances of the vehicles 104 between locations 108 of removal events. The yield map 200 includes a visual representation of the geographic area 112 that includes at least one indicator of a crop yield level, such as a map 202 with overlaid yield indicators. In some examples, the processor 118 is configured to communicate with a remote processor to generate the yield map 200.

In some examples, the processor 118 determines the crop yield levels based on movement of the vehicle 104 and detected removal events. In some examples, the processor 118 is configured to determine a first time of a first removal event and a second time of a second removal event using timestamps. The processor 118 then determines the crop yield level based at least in part on a difference between the second time and the first time. Just as the distance between removal events can be inversely proportional to the crop yield level, the time between removal events can also be inversely proportional to the crop yield level.

In some examples, the processor 118 is configured to determine a quantity of containers 106 filled within a particular area of the geographic area 112 based at least in part on the locations 108. In one or more examples, the yield map 200 includes a visual representation 202 of crop yield within the geographic area 112. In some examples, the visual representation 202 includes a map of the geographic area 112, overlaid with one or more indicators 204 representing a number of units (i.e., containers 106) for a particular area within the geographic area 112. In some examples, each indicator 204 represents a crop yield for a portion of a row 124.

In some examples, the different indicators 204 correspond to different crop yield levels. The different indicators 204, in some examples, are of different colors and/or patterns, indicating varying crop yield levels. In some examples, the processor 118 determines different indicators 204 based at least in part on the different travel distances calculated between different removal events. In some examples, a darker-colored indicator 204 indicates a greater concentration per square foot of harvested crops, or a shorter travel distance between removal events. The processor 118, in some examples, determines a crop yield level for the portion of the geographic area 112 based at least in part on an average travel distance between two removal events within that portion of the geographic area 112.

In some examples, the system 100 receives input from a user and generates the yield map 200 based at least in part on that input. In some examples, the system 100 receives the input from the user via a computing interface associated with a device, such as a laptop, tablet, mobile device, or other user device. In some examples, the user provides commands, configuration parameters, or field-specific information through a graphical user interface (“GUI”) presented on the device. In some examples, the system 100 is configured to receive input from the user via a GUI that is part of an application on which the yield map 200 is eventually displayed. In some examples, the device may communicate the input to the processor 118 through a wired or wireless connection, such as a USB link, Bluetooth connection, or network-based communication pathway.

In some examples, the user input includes a relative and or geographical location of at least one plant 120, such as locations of the rows 124 of plants 120. In some examples, the processor 118 generates the yield map 200 based at least in part on the locations of the rows 124. The processor 118, in one or more examples, is configured to generate graphical representations of the rows 124. In some examples, the processor 118 determines a crop yield level based at least in part on a location of the rows 124. In some examples, the received location of the rows 124 includes spacing between rows 124. In some examples, the processor 118 is configured to adjust a determined crop yield level based at least in part on spacing between rows 124.

In some examples, the system 100 is configured to generate a yield map 200 that accounts for the row-by-row movement of the vehicle 104. For example, as shown in FIG. 1C, a minimum distance between the second removal location 108-2 and the third removal location 108-3 may not accurately reflect the actual distance traveled by the vehicle 104 between those locations, since the vehicle traverses one row 124 and then moves to the next row 124 without removing a container 106. As such, to determine a distance traveled between the second removal event 108-2 and the third removal event 108-3, the processor 118 sums a distance d2 between the second removal event 108-2 and the border 126 and a distance d3 between the same border 126 and the third removal event 108-3.

In some examples, the processor 118 is configured to calculate a size or a location of a portion of the geographic area 112 that corresponds to a determined crop yield level based on the row 124 location. In some examples, the processor 118 determines a quantity of plants 120 harvested between two removal events based at least in part on at least one of: a width of the rows 124, a quantity of plants 120 per row 124, and/or a distance between the rows 124. The processor 118, in some examples, determines the crop yield level based at least in part on the quantity of plants. In various examples, the processor 118 assumes that the vehicle 104 travels along a length of a row 124 before moving to an adjacent row 124. As such, the processor 118, in some examples, adjusts a travel distance of the vehicle 104 based at least in part on an adjusted location of the rows 124.

In some examples, the processor 118 aggregates portions of the geographic area 112 having similar crop yield levels and overlays those portions of the yield map with the same indicator 204. In some examples, the processor 118 identifies clusters or regions of statistically similar yield values and assigns a corresponding visual indicator 204 to each region to highlight spatial trends in crop performance. In certain examples, the indicator 204 includes a color, shading pattern, or symbol that distinguishes one yield range from another, enabling easier visual interpretation by an operator. In further examples, the processor 118 adjusts the boundaries of the aggregated portions based on sensor-derived positional accuracy. In some examples, the processor 118 also stores the aggregated yield regions for subsequent analysis, comparison across growing seasons, and/or integration with other agricultural datasets.

In some examples, the system 100 identifies border points for a harvested area. In various examples, the processor 118 identifies the border points based at least in part on geospatial data or user input. In some examples, the system 100 identifies rows 124 that are borders of a harvested area and/or identifies inner harvested lines, such as harvested rows 124 within the border of the harvested area. In some examples, the system 100 determines a buffer for the harvested area. In some examples, the buffer defines an offset distance inward or outward from the detected border points to create a margin that accounts for positional uncertainty, sensor noise, or irregularities in the harvested boundary. In some examples, the system 100 uses the buffer to exclude edge effects—such as partial harvesting, overlapping passes of the vehicle 104, or incomplete rows—from yield calculations. In additional examples, the buffer allows the system 100 to delineate a refined interior region of the harvested area that is used as the basis for subsequent analyses, such as zone-based yield comparison or identification of underperforming sections within the field. In some examples, the border points are defined as removal locations 108 recorded before a transition to different row 124.

In some examples, the processor 118 identifies the border points by determining maximum and minimum coordinate values associated with a particular row 124 identifier. For geographic areas 112 having rows 124 oriented in a north-south direction, the border points include, for example, points having the highest and lowest northing values; for geographic areas 112 having rows oriented in an east-west direction, the border points include points having the highest and lowest easting values. In some examples, the processor 118 generates inner harvest lines by connecting the identified border points to sequential points along the same row 124. In contrast, in some examples, the processor 118 generates border harvest lines by projecting a line outward from the border points in a direction of an edge of the geographic area 112 (e.g., an orchard) for a fixed distance and removing or clipping any portion of the projected line that extends beyond a defined boundary. In certain examples, each harvest line is assigned a unique identifier corresponding to the container 106 or bin associated with that harvested path. In some examples, if a harvester 114 harvests multiple plants 120 in one row 124, transitions to another row 124, and then continues harvesting before the container 106 is removed, the processor 118 calculates the traveled distance for that bin to be the sum of the lengths of the harvest lines in adjacent rows by merging them into the same container 106 identifier.

In one or more examples, the system 100 is configured to receive input from a user. In some examples, the input includes a location of a border 126 of the geographic area 112, a location of a row 124, location of specific plants 120, or a combination thereof. In some examples, the processor 118 is configured to determine a distance between the border 126 and at least one of the locations 108 to accurately account for distance traveled by the vehicle 104 between removal events. In some examples, the travel distance is determined based at least in part on the distances between the locations 108 and the border 126. In some examples, the processor determines a quantity of plants 120 harvested during initial vehicle 104 movement based on the distance between the border 126 and the adjacent row 124, as additional spacing may result in more travel before the vehicle 104 encounters the first plant 120. In some examples, accounting for these border-to-row distances improves the accuracy of yield calculations by helping to ensure that plants 120 harvested near field edges are properly included in the total count.

In some examples, to generate a yield map 200, the processor 118 receives a file containing data. In some examples, the data includes information regarding removal events, such as measurements from the sensors onboard the vehicle 104. In some examples, the data includes at least one of the following: a timestamp of the removal event, a location of the removal event, a quantity of removal events, a distance between two removal events, or a combination thereof. In some examples, the processor 118 receives the data in a comma-separated values (“CSV”) file. In some examples, the processor 118 onboard the vehicle generates the CSV file based at least in part on sensor readings. In various examples, the processor 118 is configured to convert the received file to another file format. The other file format includes, for an example, a file format that stores geographic information for use in Geographic Information System (“GIS”) software. In some examples, the processor 118 converts the CSV file to a vector data file, such as a shapefile (“.shp”). In some examples, the processor 118 adds a heading to the received file. In some examples, the processor 118 verifies that each data entry includes valid coordinate information before proceeding with a conversion process for the file or generating the yield map 200. In certain examples, the processor 118 associates each removal event with a unique identifier to facilitate tracking and downstream spatial analysis. In some examples, the processor 118 generates metadata describing the source, timestamp, and structure of the converted file to ensure compatibility with external GIS tools.

In various examples, the processor 118 modifies, cleans, and/or corrects the data based at least in part on at least one of the following: user input, detected duplicates in the data, detected events, or a combination thereof. In some examples, the processor 118 receives user input. The user input includes, in some examples, a location of a row 124, spacing between rows 124, an orientation of plants 120 in a row 124, or a combination thereof. In some examples, the processor 118 modifies the data (e.g., updating and/or determining a distance between two removal events) based at least in part on the user input.

In some examples, the system 100 is configured to identify and/or generate border points of the geographic area 112 based at least in part on user input, the received data file, or a combination thereof. In some examples, the system 100 is configured to receive data regarding the geographic location (e.g., locations of rows 124 and/or plants 120) from additional devices, such as unmanned aerial vehicles (UAVs). In some examples, the system 100 is configured to generate inner borders to demark areas of different crop yield levels. In some examples, the system 100 assigns an indicator 204-1, 204-2 of crop yield level to each area such that the geographic area 112 includes multiple areas with different crop yield level indicators 204-1, 204-2. In some examples, a first indicator 204-1 includes a first overlay over a first map portion of a map 202 of the geographic area 112. The first map portion corresponds to the portion of the geographic area 112 having the crop yield level indicated by the first indicator 204-1. In some examples, the indicators 204 are superimposed onto an actual map, a generated map, a terrain view, and/or an aerial photograph of the geographic area 112. In some examples, a second indicator 204-2 includes a second overlay over a second map portion of the same map 202. In some examples, the second indicator 204-2 is based on additional travel distances between additional removal events within a portion of the geographic area 112 that is different from the portion of the geographic area 112 represented by the first indicator 204-1. In some examples, the two portions border each other, and the first indicator 204-1 borders the second indicator 204-2.

In some examples, the system 100 clips data to a border 126, removing data collected outside of a particular border 126. In some examples, the border 126 represents a predefined field perimeter, a user-selected region of interest, or an automatically generated polygon based on detected harvested areas. In certain examples, the clipping operation helps to prevent yield values, removal events, and/or positional points that fall outside the intended analysis area from influencing the resulting yield map. In some examples, the system 100 adjusts or interpolates data points that lie near the boundary 126 to avoid abrupt spatial discontinuities that may occur during the clipping process. In additional examples, the system 100 stores both the clipped dataset and the original dataset, enabling an operator to review or audit excluded points during later analysis.

Any of the functions described herein as being performed by the processor 118 may also, according to examples of the present disclosure, be performed by an additional processor. Such an additional processor includes, in some examples, a remote processor, a processor located apart from the vehicle 104, or a combination thereof. In various examples, the processor 118 provides data relating to crop yield within the geographic area 112, and a remote processor uses such data to generate the yield map 200. In some examples, the remote processor generates the yield map 200 and outputs the yield map 200 to an application accessible by a user, such as a mobile application and/or a web application. In various examples, the yield map 200 is part of a user interface.

FIG. 3A is a perspective view of one example of a system 300 for quantifying crop yield. In some examples, the system 300 is an embodiment of the system 100 shown in FIGS. 1A-C. In some examples, the system 300 includes a vehicle 104, a harvester 114 and a proximity sensor 102 onboard the vehicle 104, and a container 106 configured to hold crop 122 harvested from plants 120 by the harvester 114. As shown in FIG. 3A, in some examples, the proximity sensor 102 is mounted onto the vehicle 104 such that the crop being loaded onto the vehicle 104 and/or harvested by the harvester is within a field of view of the proximity sensor 102. In some examples, the harvester 114 directs harvested crop 122 along a chute or conveyor assembly that deposits the crop 122 into the container 106 positioned below. In certain examples, the container 106 receives the crop 122 in a free-fall arc, enabling the proximity sensor 102 to detect the motion and density of the crop 122 as it enters the container 106. In some examples, a loading and/or unloading path of the container 106 from and/or onto the vehicle 104 is also within the field of view of the proximity sensor 102.

FIG. 3B is an elevational view of the system 300 for quantifying crop yield, with the container 106 removed from the vehicle 104. In some examples, the proximity sensor 102 faces away from a forward direction of motion for the vehicle 104 and faces receiving elements 302 of the vehicle 104 that are configured to receive a container 106. In some examples, the receiving elements 302 include at least one of a truck bed, a track, a forklift, or a lift assembly configured to support and stabilize the container 106 during loading. In certain examples, the receiving elements 302 define a recessed or contoured region that aligns the container 106 under the discharge path of the harvester 114.

In some examples, the proximity sensor 102 is welded onto a frame of the vehicle 104 and/or the receiving elements 302. In some examples, the proximity sensor is installed above a forklift that holds the container 106 using a flat bracket bolted to a metal plate welded onto a frame of the vehicle 104.

In one or more examples, the system 100 includes a plurality of yield monitoring apparatuses, with each yield monitoring apparatus including a processor 118, proximity sensor 102, IMU 128, and/or GNSS receiver 116. In some examples, the user input includes a quantity of the plurality of yield monitoring apparatuses in the system. The system 100, in some examples, merges data from a plurality of yield monitors (e.g., apparatuses including a processor 118, GNSS receiver 116, and proximity sensor 102).

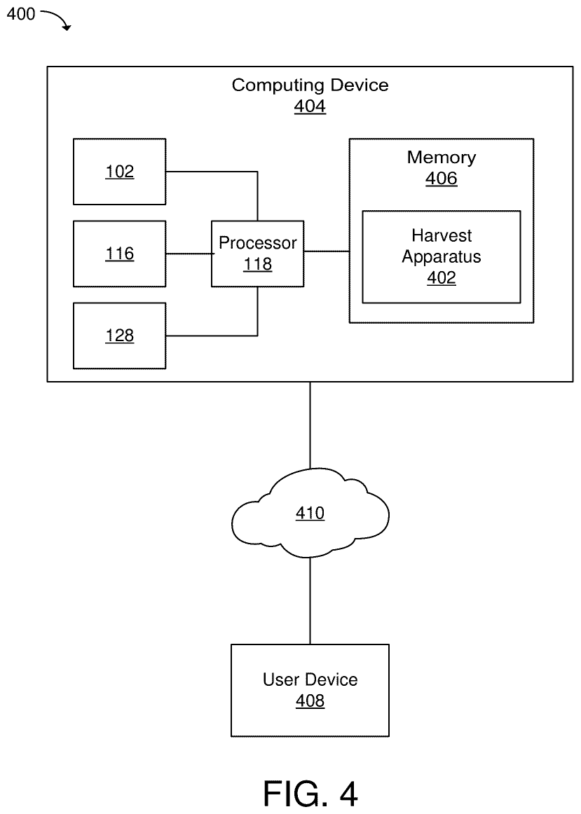

FIG. 4 is a schematic block diagram illustrating a system 400 for quantifying crop yield, according to various embodiments. In some examples, the system 400 is an embodiment of the system 100 shown in FIGS. 1A-C and/or the system 300 shown in FIGS. 3A-B. In some examples, the system 400 includes a computing device 404 communicably connected to a user device 408 over a network 410.

In various examples, the computing device 404 includes a processor 118 and memory 406 configured to execute instructions for controlling one or more functions of the system 400 and for generating data (e.g., a yield map 200, as shown in FIG. 2) for presentation on the user device 408. The network 410 includes at least one of a wired or wireless communication link and is configured to enable bidirectional communication between the computing device 404 and the user device 408. In some examples, the user device 408 is a mobile phone, tablet, laptop computer, and/or dedicated display module.

In some examples, the computing device 404 is connected to a number of sensors from which the processor 118 receives data. In some examples, the sensor at least one of the proximity sensor 102, the GNSS receiver 116, and the IMU 128. The memory 406 includes instructions that are executable to determine a crop yield level based at least in part on data received from those sensors. The memory 406, in some examples, includes instructions that are executable to generate a yield map (e.g., the yield map 200 of FIG. 2) based at least in part on the determined crop yield level. In some examples, the memory 406 includes a harvest apparatus 402 configured to determine the crop yield level and/or generate the yield map.

In some examples, the processor 118 is configured to execute code stored in the memory 406. In some embodiments, the memory 406 is volatile memory, such as random access memory (“RAM”). In some examples, the memory 406 includes all or a portion of the harvest apparatus 402, which may be loaded into the memory 406 as needed. In some examples, the computing device 404 includes data storage. The data storage includes, for example, non-volatile storage such as a solid-state drive (SSD) and a hard disk drive (HDD), or the like. In various embodiments, the memory 406 and data storage are computer readable storage media, which are non-transitory.

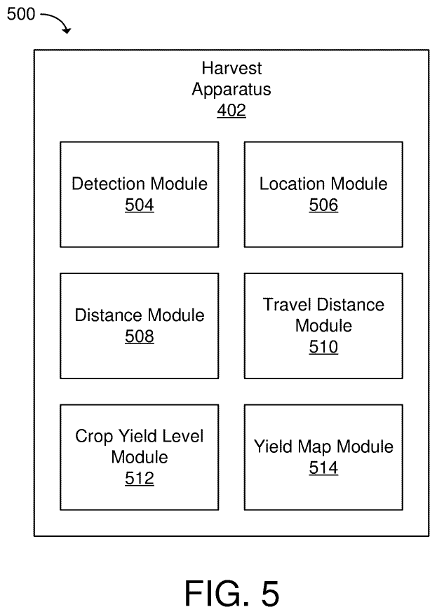

FIG. 5 is a schematic block diagram illustrating an apparatus 500 for quantifying crop yield, according to various embodiments. In some examples, the apparatus 500 is an embodiment of the harvest apparatus 402 illustrated in FIG. 4. In some examples, the apparatus 500 includes a detection module 504, a location module 506, a distance module 508, a travel distance module 510, a crop yield level module 512, and/or a yield map module 514, which are described below.

In some examples, the detection module 504 is configured to detect, via one or more sensors 102, a first removal event. The first removal event includes a removal of a first container 106-1 from a vehicle 104. The detection module 504 is also configured to detect, via the one or more sensors 102, a second removal event subsequent to the first removal event. The second removal event includes a removal of a second container 106-2 from the vehicle 104. In some examples, the second removal event includes a removal the second container 106-2 from a different vehicle.

In some examples, the location module 506 is configured to determine a first location of the vehicle 104 at the first removal event. The location module 506 is also configured to determine a second location of the vehicle 104 at the second removal event. In some examples, if the second removal event includes a removal of the second container 106-2 from a different vehicle, the location module 506 is configured to determine the location of that vehicle at the second removal event. In some examples, the location module 506 determines the first location and/or the second location based at least in part on one or more measurements from at least one location sensor onboard the vehicle 104, such as the IMU 128 and/or the GNSS receiver 116.

The distance module 508 is configured to determine a distance between the first location and the second location. The travel distance module 510 is configured to determine, based at least in part on the distance between the first location and the second location determined by the distance module 508, a travel distance of the vehicle 104.

The crop yield level module 512 is configured to determine a crop yield level based at least in part on the travel distance of the vehicle. The crop yield level, in some examples, corresponds to a portion of a geographic area that includes the first location and the second location.

The yield map module 514 is configured to generate, based at least in part on the travel distance, a yield map 200 that includes a visual representation of the geographic area. The visual representation includes an indicator 204 of a crop yield level, as determined by the crop yield level module 512.

In some examples, all or a portion of the apparatus 500 is implemented with hardware circuits. In other examples, all or a portion of the apparatus 500 is implemented using a programmable hardware device. In other examples, all or a portion of the apparatus 500 is implemented with executable code stored on computer readable storage media where the code is executable by a processor. In some examples, the computing device 404 is an FPGA, PLC, or the like and the apparatus 500 is implemented therein. In some embodiments, the apparatus 500 is split so that some of the modules 504-514 are executed on a computing device 404 on the vehicle 104 while a portion of the modules 504-514 are executed on a computing device 404 remote from the vehicle 104.

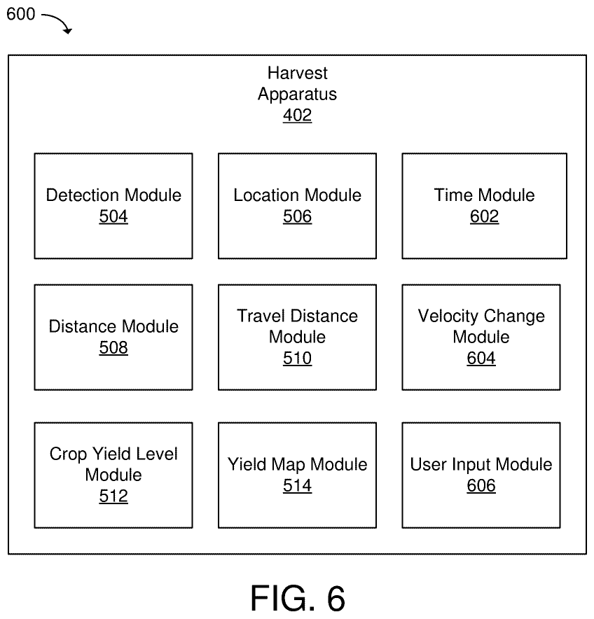

FIG. 6 is a schematic block diagram illustrating another apparatus 600 for quantifying crop yield, according to various embodiments. In some examples, the apparatus 600 is an embodiment of the apparatus 500 and/or the harvest apparatus 402. In various examples, the apparatus 600 is implemented similarly to the apparatus 500 of FIG. 5. According to some examples, the apparatus 600 includes at least one of the modules described in connection with the apparatus 500, such as the detection module 504, the location module 506, the distance module 508, the travel distance module 510, the crop yield level module 512, and/or the yield map module 514. In some examples, the apparatus 600 additionally includes a time module 602, a velocity change module 604, and/or a user input module 606, which are described below.

In some examples, the time module 602 is configured to determine a first time of the first removal event and a second time of the second removal event. In some examples, determining the crop yield level of portion of the geographic area is further based at least in part on a difference between the second time and the first time.

The velocity change module 604 is configured to determine, based at least in part on one or more measurements from a location sensor onboard the vehicle 104 (e.g., the GNSS receiver and/or the IMU 128), a change in velocity of the vehicle 104. In some examples, the location module 506 is configured to update at least one of the first location and the second location based at least in part on the change in velocity.

The user input module 606 is configured to receive, from a user (e.g., via the user device 408 shown in FIG. 4), user input. In some examples, the user input includes a location of a plurality of rows 124 of the plurality of plants 120. In some examples, the yield map module 514 is configured to generate the yield map based at least in part on the location of the rows 124. In one or more examples, the yield map module 514 is configured to generate the yield map 200 based at least in part on the location of the rows 124. In some examples, the crop yield level module 512 is configured to calculate the portion of the geographic area 112 based at least in part on the travel distance and a width of each row 124 of the plurality of rows 124.

In some examples, the user input includes a location of a border 126 the geographic area 112. In some examples, the travel distance module 510 is configured to determine a distance between the border and at least one of the first location and the second location based at least in part on the location of the border 126. In some examples, the travel distance is further based at least in part on the determined distance between the border 126 and the at least one of the first location and the second location.

In some examples, the apparatus 600 is configured to determine additional removal events and generate the yield map 200 based at least in part on those additional removal events. In some examples, the detection module 504 is configured to detect additional removal events. The detection module 504 is configured to repeat detecting the first and second removal events. In some examples, the location module 506 is configured to determine additional first and second locations, or a third location, of the vehicle 104. In some examples, the travel distance module 510 is configured to determine additional distances between the additional first and second locations and/or distances between the first and second locations and the third location. In some examples, the crop yield level module 512 is configured to determine additional crop yield levels based on the additional travel distances. In some examples, the yield map module 514 is configured to generate the yield map 200 based at least in part on the travel distance and the additional travel distances.

In some examples, the indicator 204 includes a first overlay 204-1 over a first portion of a map 220 of the geographic area 112, and the first map portion corresponds to the portion of the geographic area 112. In some examples, the yield map module 514 is configured to generate an additional indicator on the yield map 200. In some examples, the additional indicator includes a second overlay 204-2 over the second map portion of the map 220. The second map portion corresponds to an additional portion of the geographic area 112, and the additional portion includes the additional first and second locations. In some examples, the first overlay 204-1 borders the second overlay 204-2.

According to examples of the present disclosure, any operations described herein as being performed by the processor 118 may, alternatively and/or additionally, be performed by modules of the harvest apparatus 402, the apparatus 500, and/or the apparatus 600. In some examples, such modules are implemented remotely from the vehicle 104 but are in communication with the processor 118 via, for example, a network 410 connection.

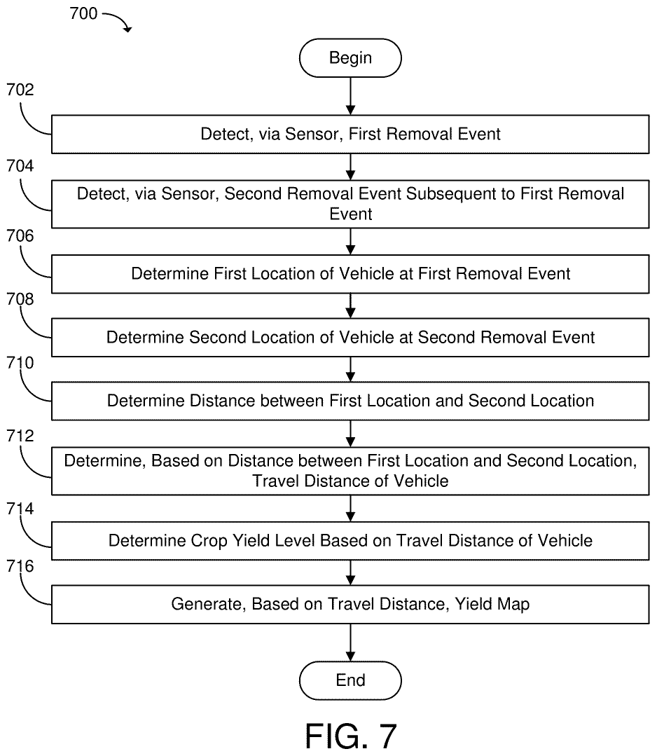

FIG. 7 is a schematic flow chart illustrating one example of a method 700 of quantifying crop yield. The method 700 begins and includes detecting 702, via a proximity sensor 102, a first removal event. In some examples, the first removal event includes a removal of a first container 106-1 from a vehicle 104. The method 700 includes detecting 704, via the proximity sensor 102, a second removal event subsequent to the first removal event. The second removal event includes a removal of a second container 106-2 from the vehicle 104. The method 700 includes determining 706 a first location of the vehicle 104 at the first removal event. The method 700 includes determining 708 a second location of the vehicle 104 at the second removal event. The method 700 includes determining 710 a distance between the first location and the second location and determining 712, based at least in part on the distance between the first location and the second location, a travel distance of the vehicle 104. The method 700 includes determining 714 a crop yield level based at least in part on the travel distance of the vehicle 104. The crop yield level corresponds to a portion of a geographic area 112 that includes the first location and the second location. The method 700 includes generating 716, based at least in part on the travel distance, a yield map 200. The yield map 200 includes a visual representation 202 of the geographic area 112. The visual representation includes an indicator 204 of the crop yield level.

In some examples, one or more steps or operations of the method 700 are performed by any combination of components of the system 100, the system 400, and/or the modules of the harvest apparatus 402. In one or more examples, one or more of the operations of the method 700 are performed by modules of an apparatus that includes the processor 118 and/or modules that receive data from at least one of the processor 118, proximity sensor 102, and/or GNSS receiver 116.

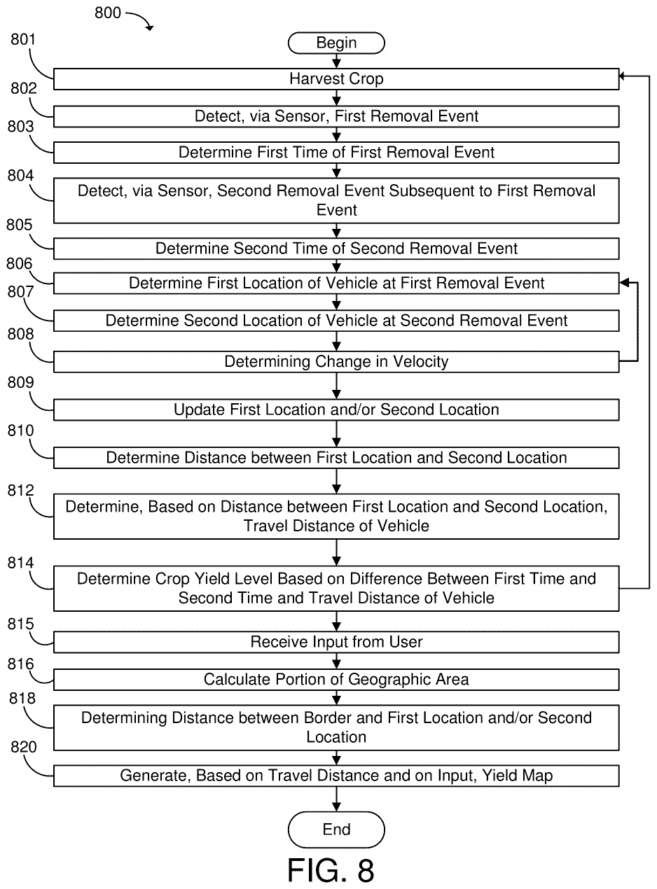

FIG. 8 is a schematic flow chart illustrating one example of a method 800 of quantifying crop yield based on travel distances. The method 800 begins and includes harvesting 801 via a harvester 114, a crop from a plant 120 of a plurality of plants 120 and transferring the crop into at least one of the first container 106-1 and the second container 106-2. The first removal event and the second removal event each include removing of a bin that includes the harvested crop. The method 800 includes detecting 802, via a proximity sensor 102, a first removal event. In some examples, the first removal event includes a removal of the first container 106-1 from a vehicle 104. The method 800 includes determining 803 a first time of the first removal event. The method 800 includes detecting 804, via the proximity sensor 102, a second removal event subsequent to the first removal event. The second removal event includes a removal of a second container 106-2 from the vehicle 104. The method 800 includes determining 805 a second time of the second removal event. In some examples, the proximity sensor 102 includes an ultrasonic proximity sensor configured to iteratively perform measurements at a predetermined time interval. In some examples, the ultrasonic proximity sensor is configured to detect at least one of the first removal event and the second removal event by detecting at least one of a presence or a lack of presence of at least one of the first container and the second container in the vehicle 104.

The method 800 includes determining 806 a first location of the vehicle 104 at the first removal event. The method 800 includes determining 807 a second location of the vehicle 104 at the second removal event. In some examples, determining 806 the first location and the determining 807 the second location is based at least in part on one or more measurements from at least one of an Inertial Measurement Unit (IMU) and a Global Navigation Satellite System (GNSS) receiver located on the vehicle 104. The method 800 includes determining 808, based at least in part on the one or more measurements, a change in velocity of the vehicle 104 and updating 809 at least one of the first location and the second location based at least in part on the change in velocity.

The method 800 includes determining 810 a distance between the first location and the second location and determining 812, based at least in part on the distance between the first location and the second location, a travel distance of the vehicle 104. The method 800 includes determining 814 a crop yield level based at least in part on the travel distance of the vehicle 104. The crop yield level corresponds to a portion of a geographic area 112 that includes the first location and the second location. In some examples, determining 814 the crop yield level of the portion of the geographic area 112 is further based at least in part on a difference between the second time and the first time.

In some examples, the method 800 includes repeating detecting 802, 804 first and second removal events, determining additional first and second locations of the vehicle 104, determining additional distances between the additional first and second locations, determining additional travel distances of the vehicle 104, and determining additional crop yield levels for the additional travel distances.

The method 800 includes receiving 815, from a user, input that includes a location of a plurality of rows of the plurality of plants. In some examples, the method 800 includes calculating 816 the portion of the geographic area based at least in part on the travel distance and a width of each row of the plurality of rows. In some examples, the input includes a location of a border 126 of the geographic area 112. The method 800 includes determining 818 a distance between the border 126 and at least one of the first location and the second location. The travel distance is further based at least in part on the determined distance between the border 126 and the at least one of the first location and the second location.

The method 800 includes generating 820, based at least in part on the travel distance, a yield map 200. The yield map 200 includes a visual representation 202 of the geographic area 112. The visual representation includes an indicator 204 of the crop yield level. In some examples, generating 820 the yield map is further based at least in part on the location of the plurality of rows.

In some examples, generating 820 the yield map 200 includes generating the yield map 200 based on the travel distance and the additional travel distances. The indicator includes a first overlay 204-1 over a first map portion of a map 202 of the geographic area 112. The first map portion corresponds to the portion of the geographic area 112. Generating 820 the yield map 200 based on the additional travel distances includes generating an additional indicator on the yield map 200. The additional indicator includes a second overlay 204-2 over a second map portion of the map 202. The second map portion corresponds to an additional portion of the geographic area 112. The additional portion includes the additional first and second locations. The first 204-1 overlay borders the second overlay 204-2.

The present invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for quantifying crop yield, the method comprising:
detecting, via a sensor, a first removal event, the first removal event comprising a removal of a first container from a vehicle;
detecting, via the sensor, a second removal event subsequent to the first removal event, the second removal event comprising a removal of a second container from the vehicle;
determining a first location of the vehicle at the first removal event;
determining a second location of the vehicle at the second removal event;
determining a distance between the first location and the second location;
determining, based at least in part on the distance between the first location and the second location, a travel distance of the vehicle;
determining a crop yield level based at least in part on the travel distance of the vehicle, wherein the crop yield level corresponds to a portion of a geographic area comprising the first location and the second location; and
generating, based at least in part on the travel distance, a yield map comprising a visual representation of the geographic area, the visual representation comprising an indicator of the crop yield level.

2. The method of claim 1, further comprising:
determining a first time of the first removal event; and
determining a second time of the second removal event,
wherein determining the crop yield level of portion of the geographic area is further based at least in part on a difference between the second time and the first time.

3. The method of claim 1, wherein determining the first location and the second location is based at least in part on one or more measurements from at least one of an Inertial Measurement Unit (IMU) and a Global Navigation Satellite System (GNSS) receiver located on the vehicle.

4. The method of claim 3, further comprising determining, based at least in part on the one or more measurements, a change in velocity of the vehicle and updating at least one of the first location and the second location based at least in part on the change in velocity.

5. The method of claim 1, further comprising harvesting, via a harvester, a crop from a plant of a plurality of plants and transferring the crop into at least one of the first container and the second container, wherein the first removal event and the second removal event each comprise removing of a bin comprising the harvested crop.

6. The method of claim 1, further comprising receiving, from a user, input comprising a location of a plurality of rows of the plurality of plants, wherein generating the yield map is further based at least in part on the location of the plurality of rows.

7. The method of claim 6, further comprising calculating the portion of the geographic area based at least in part on the travel distance and a width of each row of the plurality of rows.

8. The method of claim 1, further comprising:
receiving input from a user, the input comprising a location of a border of the geographic area; and
determining a distance between the border and at least one of the first location and the second location,
wherein the travel distance is further based at least in part on the determined distance between the border and the at least one of the first location and the second location.

9. The method of claim 1, wherein the sensor comprises an ultrasonic proximity sensor configured to iteratively perform measurements at a predetermined time interval.

10. The method of claim 9, wherein the ultrasonic proximity sensor is configured to detect at least one of the first removal event and the second removal event by detecting at least one of a presence or a lack of presence of at least one of the first container and the second container in the vehicle.

11. The method of claim 1, further comprising repeating detecting first and second removal events, determining additional first and second locations of the vehicle, determining additional distances between the additional first and second locations, determining additional travel distances of the vehicle, and determining additional crop yield levels for the additional travel distances, and wherein generating the yield map comprises generating the yield map based on the travel distance and the additional travel distances.

12. The method of claim 11, wherein:
the indicator comprises a first overlay over a first map portion of a map of the geographic area, the first map portion corresponding to the portion of the geographic area;
generating the yield map based on the additional travel distances comprises generating an additional indicator on the yield map, wherein:
the additional indicator comprises a second overlay over a second map portion of the map;
the second map portion corresponds to an additional portion of the geographic area; and
the additional portion comprises the additional first and second locations; and
the first overlay borders the second overlay.

13. A system, comprising:
a proximity sensor configured to:
detect a first removal event, the first removal event comprising a removal of a first container from a vehicle; and
detect a second removal event, the second removal event comprising a removal of a second container from the vehicle;
a location sensor configured to:
determine a first location of the vehicle at the first removal event; and
determine a second location of the vehicle at the second removal event; and
a processor configured to:
determine a distance between the first location and the second location;
determine, based at least in part on the distance between the first location and the second location, a travel distance of the vehicle;
determine a crop yield level based at least in part on the travel distance of the vehicle, wherein the crop yield level corresponds to a portion of a geographic area comprising the first location and the second location; and
generate, based at least in part on the travel distance, a yield map comprising a visual representation of the geographic area, the visual representation comprising an indicator of the crop yield level.

14. The system of claim 13, wherein:
the location sensor is further configured to:
record a first timestamp for the first removal event; and
record a second timestamp for the second removal event; and
the processor is further configured to:
determine a time of the first removal event based on the first timestamp;
determine a time of the second removal event based on the second timestamp; and
determine the crop yield level of the portion of the geographic area based at least in part on a difference between the second time and the first time.

15. The system of claim 13, wherein the location sensor comprises at least one of an Inertial Measurement Unit (IMU) and a Global Navigation Satellite System (GNSS) receiver located on the vehicle.

16. The system of claim 13, further comprising an Inertial Measurement Unit (IMU) configured to determine, based at least in part on one or more measurements, a change in velocity of the vehicle, wherein the processor is further configured to update at least one of the first location and the second location based at least in part on the change in velocity.

17. The system of claim 13, further comprising a harvester configured to harvest a crop from a plant of a plurality of plants and transfer the crop into at least one of the first container and the second container, wherein the first removal event and the second removal event each comprise removing of a bin comprising the harvested crop.

18. The system of claim 13, wherein the proximity sensor comprises an ultrasonic proximity sensor configured to iteratively perform measurements at a predetermined time interval.

19. The system of claim 18, wherein the ultrasonic proximity sensor is configured to detect at least one of the first removal event and the second removal event by detecting at least one of a presence or a lack of presence of at least one of the first container and the second container in the vehicle.

20. A system, comprising:
a vehicle;
a proximity sensor onboard the vehicle and configured to:
detect a first removal event, the first removal event comprising a removal of a first container from a vehicle; and
detect a second removal event, the second removal event comprising a removal of a second container from the vehicle;
a location sensor onboard the vehicle and configured to:
determine a first location of the vehicle at the first removal event; and
determine a second location of the vehicle at the second removal event; and
a processor configured to:
determine a distance between the first location and the second location;
determine, based at least in part on the distance between the first location and the second location, a travel distance of the vehicle;
determine a crop yield level based at least in part on the travel distance of the vehicle, wherein the crop yield level corresponds to a portion of a geographic area comprising the first location and the second location; and
generate, based at least in part on the travel distance, a yield map comprising a visual representation of the geographic area, the visual representation comprising an indicator of the crop yield level.
